(19) United States
(12) Patent Application Publication
(10) Pub. No.: US 2009/0280463 A1
(43) Pub. Date: Nov. 12, 2009

(54) Systems and methods for goal attainment in achievement of learning

(76) Inventor: David Yaskin, Arlington, VA (US)

Correspondence Address: MCDERMOTT, WILL & EMERY, 11682 EL CAMINO REAL, SUITE 400, SAN DIEGO, CA, 92130-2047, US

(21) Appl. No.: 12/151,593

(22) Filed: May 6, 2008

(51) Int. Cl. G09B 7/00

(52) U.S. Cl. 434/323

(57) ABSTRACT

Systems and methods are provided for measuring how well a student achieves learning outcomes. A student identification card or an electronic device may be associated with a student that may contain student data or other student information. The card or device may be swiped, read by a proximity reader, engaged in an interchange of information based on a received request, or be subject to any other registration by the system. The registered use of the card or device based on student interactions may be associated with particular student outcomes. Goal attainment may be determined on a per student basis, with each student having corresponding student data stored in a database. The system may be configured to utilize factor analysis to determine which interactive student data characteristics, including those determined by card or device registration by the system, have increased correlation with attaining the predefined goal of achieving one or more learning outcomes.

### FIELD

The present disclosure generally relates to computer software and hardware systems, and, in particular, relates to systems and methods for assessing student performance in achieving learning outcomes.

### BACKGROUND

Presently, educational institutions have various expected learning outcomes for students. These institutions often strive to build a campus that encourages learning both inside and outside the classroom, as well as foster personal growth. The physical campus, co-curricular activities, extra-curricular activities, campus computer networks that foster on-line communities, and other services typically contribute to achieving learning outcomes. Educational institutions endeavor to offer many academic programs, as well as create a diverse student experience as part of a holistic approach to education.

Educational institutions can typically determine whether a student has fulfilled a particular goal (e.g., a student has demonstrated an ability to gather information from an array of sources to support a thesis in a research paper). However, such institutions find it difficult to determine which factors in a student's overall experience significantly contributed to a student achieving a goal or a learning outcome. It is equally difficult for an educational institution to determine which factors were detrimental to or created obstacles for the student in achieving goals or learning outcomes. Knowing which factors are helpful or harmful for a student in achieving goals or learning outcomes is desirable in fostering an environment to attract and retain students.

Accordingly, there exists a need for systems and methods to create improved learning outcomes for students, and determine which student experience factors have the greatest correlation with a student attaining goals and achieving learning outcomes.

### SUMMARY

Exemplary embodiments provide systems and methods for the measuring of how well a student achieves learning outcomes. These outcomes may relate, for example, to institutional level outcomes, program level outcomes, and course level outcomes. A student identification card, an electronic device, and/or universal account may be associated with a student that may contain student data or other student information. The card or device may be swiped, read by a proximity reader, engaged in an interchange of information based on a received request, or be subject to any other registration by the system. This swiping or interchange of information may provide a record of student interactions. For example, the student interactions may include how frequently a student has attended class, visited the library, utilized entertainment offerings on- or off-site from an educational campus, participated in educational online organizations, attended educational events or lectures outside of class, utilized off campus merchants, or any other suitable activities. Alternatively, student interaction data may be captured at a login event for an educational institution computer network, or with the submission of an electronic document for educational or administrative purposes.

The registered use of the card or device may be associated with particular student outcomes. Goal attainment may be determined on a per student basis, with each student having corresponding student data stored in a database associated with the system. The student data may be based at least in part on the data acquired by the registration of the card or electronic device. Student data may include, but is not limited to, demographics, organizational affiliation, courses completed and/or selected, degree program, certificate programs, grades, activities, community service, any combination thereof, or any other suitable information. The system may be configured to utilize factor analysis to determine which student data characteristics (including student interaction data captured by card or device registration with the system) have increased correlation with attaining the predefined goal of achieving one or more learning outcomes.

Exemplary systems and methods may relate to electronically assessing student performance in achieving one or more learning outcomes. The systems and methods may define one or more goals for the one or more learning outcomes for a student. Student interaction data may be captured, wherein the student interaction data has one or more data elements. The systems and methods may determine whether the student has achieved the one or more goals based on the captured student interaction data. The systems and methods may also determine which captured data elements have increased correlation with the student attaining the defined one or more goals.

Exemplary systems and methods may relate to electronically correlating student interactions with student performance in achieving one or more learning outcomes. The systems and methods may capture student interaction data, wherein the student interaction data has one or more data elements. At least some of the captured data elements may be correlated with the one or more learning outcomes. The systems and methods may determine which captured data elements have increased correlation with the student achieving the one or more learning outcomes.

The disclosure also encompasses program products for implementing assessment systems for student performance in achieving one or more learning outcomes of the type outlined above. In such a product, the programming is embodied in or carried on a machine-readable medium.

Additional features will be set forth in the description below, and in part will be apparent from the description, or may be learned by practice of the exemplary embodiments. The exemplary embodiments will be realized and attained by the structure particularly pointed out in the written description and claims hereof as well as the appended drawings.

It is to be understood that both the foregoing general description and the following detailed description are exemplary and explanatory and are intended to provide further explanation of the claims.

### BRIEF DESCRIPTION OF THE DRAWINGS

The accompanying drawings, which are included to provide further understanding of the exemplary embodiments and are incorporated in and constitute a part of this specification, illustrate embodiments and together with the description serve to explain the embodiments. In the drawings:

FIG. 1 illustrates an exemplary block-level diagram of an institutional environment in which a student performance assessment system is implemented according to an exemplary embodiment;

FIG. 2 is a flow diagram for assessing student performance in achieving learning outcomes according to an exemplary embodiment;

FIG. 3 illustrates a display that enables a user to establish institutional level goals, program level goals, and course level goals according to an exemplary embodiment;

FIG. 4 illustrates a display indicating student attendance or participation in various events according to an exemplary embodiment;

FIG. 5 illustrates a display indicating frequency of class attendance according to an exemplary embodiment;

FIG. 6 depicts a display indicating student and educational course information according to an exemplary embodiment;

FIG. 7 depicts a display indicating course-specific event information according to an exemplary embodiment;

FIGS. 8A-8B illustrate displays indicating student performance on rubrics according to an exemplary embodiment;

FIG. 9 illustrates institutional level goal displays, as well as factors relating to goal attainment according to an exemplary embodiment;

FIGS. 10A-B illustrate program level goal displays, as well as factors relating to goal attainment according to an exemplary embodiment;

FIGS. 11A-11B illustrate course level goal displays, as well as factors relating to goal attainment according to an exemplary embodiment; and

FIG. 12 illustrates statistical correlation information determined and presented by the student performance assessment system according to an exemplary embodiment.

### DETAILED DESCRIPTION

In the following detailed description, numerous specific details are set forth to provide a full understanding of the exemplary embodiments. It will be obvious, however, to one ordinarily skilled in the art that the embodiments may be practiced without some of these specific details. In other instances, well-known structures and techniques have not been shown in detail so as not to obscure the embodiments.

As generally used herein, the term “mission” is a broad statement that describes the over-arching purpose of an organization (e.g., educational institution). Mission statements typically are not measurable because of the scope that they encompass and because they are not time-constrained. Missions are frequently broken down further into a series of “goals.” Though more specific than a mission, goals are still broad statements and may not be easily measurable. Goals provide guidance on areas that should be addressed through specific, measurable objectives. The term “outcome” is the achieved result or consequence of some activity (e.g. instruction or some other performance). Frequently, the term is used with a modifier to clarify the activity. An “institutional level outcome” is an outcome that is the achieved result or consequence of some activity as determined at an educational institutional level. A “program level outcome” is an outcome that is the achieved result or consequence of participating in and/or successfully completing an educational program, wherein the program may include one or more educational courses (e.g., for a degree program or certificate program). A “course level outcome” is the achieved result or consequence of participation in a particular educational course of study (e.g., a Calculus I class, an American Literature class, etc.).

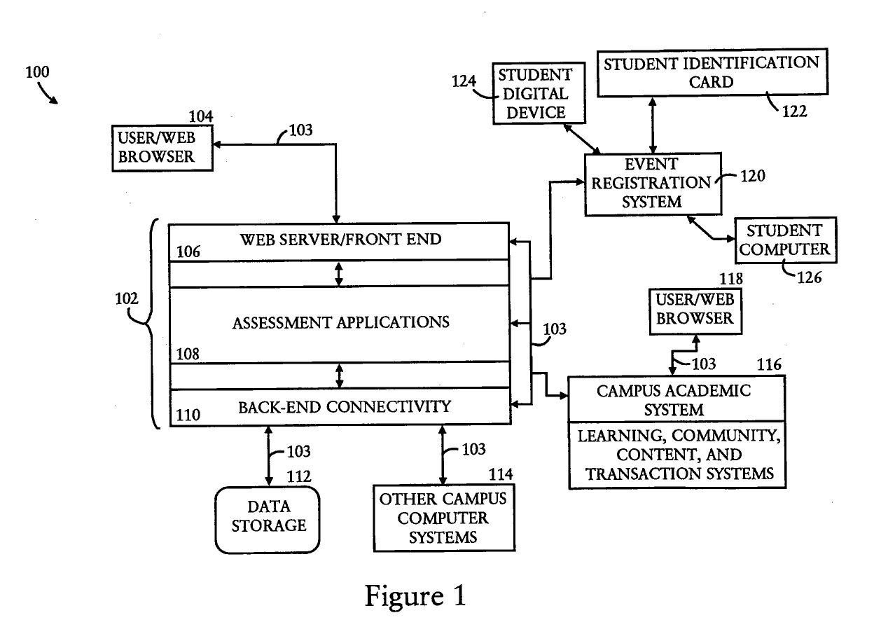

FIG. 1 depicts a functional block diagram of an exemplary student performance assessment system 100. As described in more detail herein, student performance assessment system 100 may provide a framework for performing goal attainment analysis as related to achievement of learning by students in, for example, an educational institution. Computing system 102 may be one or more computers (e.g., one or more servers, personal computers, minicomputers, mainframe computers, or any other suitable computing devices, or any combination thereof) that may be configured with front-end 106, goal attainment assessment applications 108, and back-end connectivity 110.

User computer 104 may be configured to communicate with computer system 102 via a web browser or similar interface to communicate with an appropriately configured front-end 106 of system 102. Communication between user computer 104 and front end 106 of computer system 102 may be via communications link 103, which may be a wireless or wired communications link such as a local area network, wide area network, the Internet, or any other suitable communications network. Front-end 106 may be, for example, a web server or other computing device hosting one or more applications 108 that user computer 104 may access. Applications 108 may be one or more software components or programs that execute on a programmable computer platform of computer system 102 to provide functionality related to performing student performance assessment in achieving learning outcomes. Such applications 108 may include components for defining goals for learning outcomes, capturing data related to learning outcomes, determining whether one or more students have achieved the defined goals, determining which captured data elements have increased correlation with the student attaining the defined goals, or reporting the data, or any other suitable components, or any combination thereof.

Computing system 102 may also access data storage facilities 1 12 and other computer systems 114 via communications link 103. For example, data storage facilities 112 may be one or more digital data storage devices configured with one or more databases having student data (e.g., student identification number, student name, student gender, student race, courses completed, courses enrolled in, degree program, certificate program, etc.) and may also contain data received from a registration event with a student identification card, device configured with student information, and/or from registering an event by which a student entered identification data (e.g., a login event to a educational institution computer network application using student identification information). Data storage facilities 112 may store and arrange data in a convenient and appropriate manner for manipulation and retrieval. Other computer systems 114 may be a variety of third-party systems that contain data or resources that are useful for the student performance assessment system 100. In the exemplary higher education environment, systems 114 may include a student information system (SIS) that maintains student demographic information. Systems 114 may also include an electronically maintained class or course schedule for the institution that includes information about the courses such as section numbers, professors, class size, department, college, the students enrolled, etc. Other campus-related systems such as financial aid and the bursar's office may be included in systems 114 of FIG. 1.

Back-end connectivity 110 of computer system 102 may be appropriately configured software and hardware that interface between the applications 108 and resources including, but not limited to, data storage 112 and other computer systems 114 via communications link 103.

Another resource to which the back end 110 may provide connectivity (e.g., via communications link 103) is a campus (or institutional) academic system 116. Campus academic system 116, in an academic environment, provides a platform that allows students and teachers to interact in a virtual environment based on the courses for which the student is enrolled. This system may be logically separated into different components such as a learning system, a content system, a community system, or a transaction system, or any other suitable system, or any combination thereof. For example, a student, administrator, faculty or staff member may operate user computer 118 to access academic system 116 via a web browser or similar interface.

Of particular usefulness to system 100, academic system 116 may provide a virtual space that user computer 118 may visit to receive information and to provide information. One exemplary arrangement provides user computer 118 with a webpage where general information may be located and that has links to access course-specific pages where course-specific information is located. Electronic messaging, electronic drop boxes, and executable modules may be provided within the user's virtual space on the academic system 116. Thus, with respect to computer system 102, one of applications 108 may be used to generate information that is to be deployed to one or more users of academic system 116. Via back-end 110, the information may be sent to academic system 116 where it is made available to user computer 118 just as any other information may be made available. Similarly, from within the academic system 116, the user may enter and submit data that is routed through the back end 110 to one of the applications 108. Academic system 116 and computer system 102 may be more closely integrated so that the connectivity between the applications 108 and the system 116 is achieved without a network connection or back end software 110.

System 102 may be communicatively coupled to one or more registration systems 120, which may be a card reader, proximity reader, or other suitable system configured to capture information from student identification card 122, student digital device 124 (e.g., cellular phone, personal digital assistant, handheld computing device, laptop computer, etc.), or student computer 126. Although only one student identification card 122, student digital device 124, and student computer 126 are shown, there may be one or more of each respective device that may communicate with registration system 120. Identification card 122, digital device 124, and/or student computer 126 may be configured with student identification information (e.g., student name, student identification number, gender, race, major, dining services plan, etc.). For example, student identification card 122 may be swiped, scanned, or registered by proximity by registration system 120 at an event (e.g., student attending class, cultural event, entertainment event, athletic event, etc.) to capture and associate attendance by the student at the particular event. Alternatively, student digital device 124 may communicate student identification information via a wired or wireless communications link with registration system 120 at an event. Also, student computer 126 may communicate with registration system 120 to provide student information at a login event or other information exchange event (e.g., electronic homework assignment submission by a student, wherein registration system captures the student identification information, as well as one or more data elements regarding the course and the assignment submission, etc.). Data captured by registration system 120 may be transmitted to computer system 102 via communications link 103 for processing (e.g., by applications 108, etc.) and/or storage (e.g., stored in data storage 112, etc.).

Data may be captured from student identification card 122 or student digital device 124 related to presence, utilizations, and transactions by a student. For example, a student may use card 122 or device 124 to purchase a ticket for a concert for the city symphony or a ticket for an exhibit at the city art museum. Card 122 or device 124 may be enabled with banking account, declining balance account, or credit card account information, or other financial transaction enabling information to facilitate the purchase of the tickets. Additionally, attendance of the symphonic concert or art museum exhibit by the student may be registered by registration system 120, which may be present at the city symphonic hall where the concert is being performed or at the art museum in order to receive student identification data and event information data (e.g., concert information, location of symphony hall, time of attendance, etc.) from the swiping or registering of student identification card 122 or device 124.

In another example, a student may use card 122 or device 124 to purchase a bus ticket or bus pass from the city's transportation authority. Again, card 122 or device 124 may also be enabled with banking account, declining balance account, or credit card account information, or other financial transaction enabling information to facilitate the purchase of the bus ticket (e.g., single ride, round-trip, etc.) or bus pass (e.g., 2 ride pass, 4 ride pass, weekly pass, weekend pass, monthly pass, academic year pass, year pass, etc.). Alternatively, a student may purchase a bus pass or ticket with card 122 or device 124, and information related to the pass or ticket may be associated with card 122 or device 124. Upon using the bus with card 122 or device 124 having associated bus pass or ticket information, the bus may be equipped with at least a portion of registration system 120 to register student use of the bus (e.g., identification information of the student, bus route information, time used, etc.) and may deduct from the bus use allowance of the purchased bus ticket or pass (e.g., deduct a day of use from the weekly pass purchased from the student's account, etc.).

In yet another example, a student may use card 122 or device 124 to purchase a pizza from an off-campus merchant, or purchase a Calculus study guide from the on-campus bookstore. During the purchasing transaction, card 122 may be swiped or read by a proximity reader (e.g., event registration system 120), and data may be captured such as the identity of the student, the location of the purchase (e.g., name and location of off-campus vendor), and data related to the items that were purchased (e.g., large pepperoni pizza; title, author, and publisher of the Calculus study guide purchased; cost of the items, etc.). Card 122 or device 124 may also be enabled with banking account, declining balance account, or credit card account information, or other financial transaction enabling information to facilitate the purchase of the items. In another example, student computer 126 may be used in an on-line purchasing transaction with an on-line merchant, wherein the student identification, identification information related to the items purchased, and information related to the on-line vendor may be captured by event registration system 120 (e.g., student computer 126 may transmit the information to event registration system 120 after the transaction).

Event registration system 120 may capture presence and utilization data by capturing data from student identification card 122, digital data device 124, and/or student computer 126 at particular events. For example, card 122 may be scanned (e.g., using event registration system 120) at the entrance of the educational institution's library (e.g., card 122 may be scanned at the entrance and exit of the library to record the times associated with entering and leaving), and may be scanned again when a student checks out a book. Thus, event registration system 120 may capture data related to the identity of the student, as well as the duration of time that the student was in the library, and information related to the book that the student checked out (e.g., author, title, genre, etc.). Similar registration of card 122 or device 124 by event registration system 120 may occur, for example, if the student attends a sporting event (e.g., a football game, etc.) or a cultural event such as a music concert (e.g., concert by string quartet, chamber orchestra, jazz band, etc.).

Although front end 106, applications 108, and back end 110 of the assessment system 102 are each depicted as a single block in FIG. 1, one of ordinary skill will appreciate that each may also be implemented using a number of discrete, interconnected components. As for the communication links between the various blocks of FIG. 1, a variety of functionally equivalent arrangements may be utilized. For example, some links may be via the Internet or other wide-area network, while other links may be via a local-area network or even a wireless interface. Also, although only a single computer 104 of the assessment system 102 is explicitly shown, multiple users and multiple computers or computing devices may be utilized in system 100. The structure of FIG. 1 is logical in nature and does not necessarily reflect the physical structure of such a system. For example, the assessment system 102 may be distributed across multiple computer platforms as can the data storage 108. Furthermore, components 106, 108, 110 are separate in the figure to simplify explanation of their respective operation. However, these functions may be performed by a number of different, individual components, or a more monolithically arranged component. Additionally, any of the three logical components 106, 108, 110 may directly communicate with the academic system 116 without an intermediary. Also, although the users 104, 118 are depicted as separate entities in FIG. 1, they may, in fact, be the same user or a single web browser instance concurrently accessing both the assessment system 102 and the academic system 116. Further, data storage 112 may be separate from, or included on, the assessment system 102.

Student performance assessment relating to attaining goals and achieving learning outcomes within an institution such as a higher-education academic institution is a complex undertaking that encompasses many different levels of evaluation, data collection, and correction. For example, at the institutional level, a university may be focused on assessing general education skills such as research, writing, public speaking, and ethical behavior, and may be encouraging student attendance of educational lectures outside of class, cultural events, athletic activities, or community service, or other suitable goals. At the program level, the goals may be for achieving predefined skills associated with an academic program. For example, in a political science program, an institution may assess whether a student is capable of analyzing and explaining modern diplomatic and political actions by government officials based on a student's knowledge of historical diplomatic and political negotiations. For a physics program, an educational institution may have a program level goal of enabling physics students to be able to apply scientific problem solving techniques to classical areas of physics, as well as to modern physics. At the course level, the goals may be to achieve specific skills or knowledge. For example, in an introductory physics course, a goal may be for a student to understand and be able to apply the laws of classical mechanics (e.g., describe objects in motion). Thus, system 100 may be used to assess whether the institutional level goals, program level goals, or course level goals have been attained, and which factors had an increased contribution to a student achieving these learning goals.

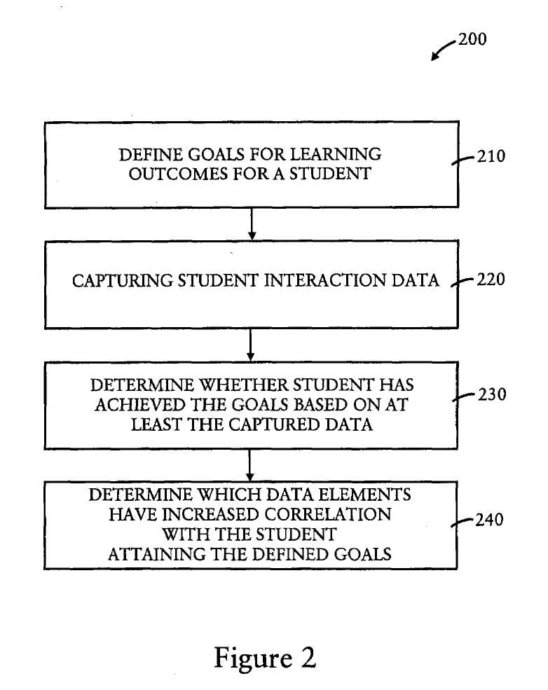

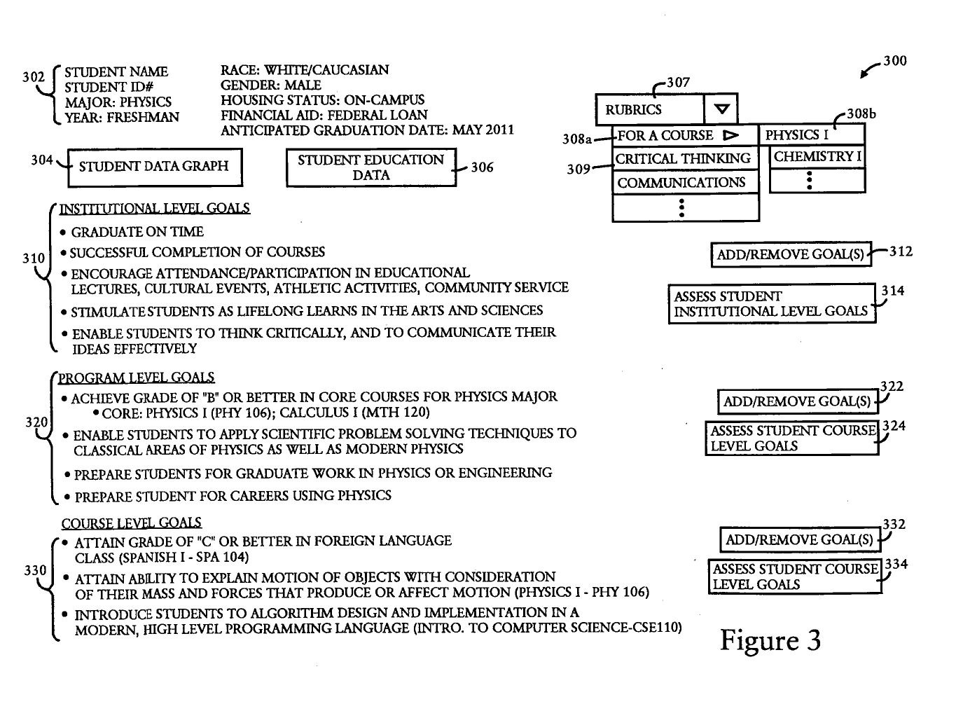

FIG. 2 depicts an exemplary diagram for flow 200 for assessing student performance in achieving one or more learning outcomes. Computer system 102 (FIG. 1) configured with goal attainment student assessment application 108 may, for example, perform flow 200. At block 210, one or more goals for student learning outcomes may be defined for a student. These goals may include, for example, institutional level goals, program level goals, or course level goals. The goals may be established by, for example, an administrator or other individual using display 300 of FIG. 3, as described in detail below.

At block 220, system 100 may capture (e.g., using registration system 120) student interaction data (e.g., student attending a cultural event, class, submitting an assignment electronically, buying a study guide, utilizing public transportation, etc.), wherein the student interaction data has one or more elements. Interaction data captured at block 220 may be presence data or non-presence data. The captured presence data may relate to, for example, how frequently a student has attended class, visited the library, utilized entertainment offerings on- or off-site from an educational campus, participated in educational online organizations, attended educational events or lectures outside of class, or any other suitable activities, or any combination thereof. Captured non-presence data may include, for example, student patronage of on-campus merchants, student patronage of off-campus merchants, student patronage of on-line merchants, student electronic submission of an assignment, or student electronic submission of student identification information, student utilization of an on-campus resource (e.g., checking out a library book, usage of a computer lab or athletic facility, etc.), student utilization of an off-campus resource, any transactional or utilization information, or any combination thereof.

At block 230, system 100 may determine whether a student has achieved one or more defined goals (e.g., goals defined at block 210) based on the captured student interaction data at block 220. Alternatively, the captured data may include data captured from registration system 120 or student data from campus academic system 116. At block 230, computer 102 of system 100 may compare the captured interaction data, student data (e.g., from campus academic system 116, data storage 112, and/or campus computer system 114), or any combination thereof with the one or more defined goals, and determine whether the goals were attained. Again, goals may be related to institutional level goals, program level goals, or course level goals.

At block 240, computer system 102 of system 100 may determine which captured student interaction data elements have increased correlation with the student attaining the one or more defined goals. Computer 102 may also use other student data (e.g., data from campus academic system 116, data storage 112, and/or campus computer system 114), either alone or in combination with the captured student interaction data, to determine which data elements may have increased correlation with the student attaining the one or more defined goals. Student data may include, but is not limited to student demographic data, student degree program, student certificate program, courses completed, course type (e.g., on-line courses, distance learning courses, on-campus courses, summer courses, continuing education courses, etc.), courses needed for completion of the degree or certificate program, program rubric data, course rubric data, skills rubric data (e.g., critical thinking rubric data, communication rubric data, etc.), or any other suitable information, or any combination thereof. System 102 may utilize factor analysis in order to determine which data elements have increased correlation with a student achieving a particular goal, as described in further detail below.

Factor analysis may be used by the exemplary systems described herein (e.g., system 100 of FIG. 1) as a statistical data reduction technique that may be used to explain variability among observed random variables in terms of fewer unobserved random variables (i.e., factors). The observed variables may be modeled as linear combinations of the factors. An advantage of factor analysis is the reduction of the number of variables by combining two or more variables into a single factor. Accordingly, factor analysis may be used for data reduction. For example, specific factors may be combined into a general, overarching factor such as academic performance. Another advantage of factor analysis is the identification of groups of inter-related variables to determine how they are related to each other. Thus, factor analysis may also be used as a structure detection technique. For example, student attendance of cultural events and participation in on-line educational community groups may relate to successfully achieving a defined goal.

Correspondence analysis also may be performed by the exemplary systems as described herein. Correspondence analysis may be used, for example, to analyze two-way and multi-way tables containing one or more measures of correspondence between data (i.e., data in the rows and columns of the table). The results may provide information which is similar in nature to those produced by factor analysis techniques. The structure of categorical variables included in the table may be identified and summarized for presentation to a user (e.g., administrator, faculty member, etc.).

In using factor analysis as a variable reduction technique, the correlation between two or more variables may be summarized by combining two variables into a single factor. For example, two variables may be plotted in a scatterplot. A regression line may be fitted (e.g., by computer system 102 of FIG. 1) that represents a summary of the linear relationships between the two variables. For example, if there are two variables, a two-dimensional plot may be performed, where the two variables define a plane. With three variables, a three-dimensional scatterplot may be determined, and a plane could be fitted through the data. With more than three variables it becomes difficult to illustrate the points in a scatterplot, but the analysis may be performed by computer system 102 to determine the regression summary of the relationships between the three or more variables. A variable may be defined that approximates the regression line in such a plot to capture the principal components of the two or more items. Data scores from student data on the new factor (i.e., represented by the regression line) may be used in future data analyses to represent that essence of the two or more items. Accordingly, two or more variables may be reduced to one factor, wherein the factor is a linear combination of the two or more variables.

The extraction of principal components may be found by determining a variance maximizing rotation of the original variable space. For example, in a scatterplot, the regression line may be the original X-axis, rotated so that it approximates the regression line. This type of rotation is called variance maximizing because the criterion for (i.e., goal of) the rotation is to maximize the variance (i.e., variability) of the “new” variable (factor), while minimizing the variance around the new variable. Although it is difficult to perform a scatterplot with three or more variables, the logic of rotating the axes so as to maximize the variance of the new factor remains the same.

After a line has been determined on which the variance is maximal, some variability remains around this first line. Upon extraction of the first factor (i.e., after the first line has been drawn through the data), another line may be defined that maximizes the remaining variability. In this manner, consecutive factors may be extracted. Because each consecutive factor is defined to maximize the variability that is not captured by the preceding factor, consecutive factors are independent of each other. Thus, consecutive factors are uncorrelated or orthogonal to each other.

In applying principal component analysis as a data reduction method (i.e., a method for reducing the number of variables), the number of factors desired to be extracted may be selected. As consecutive factors are extracted, the factors may account for decreasing variability. One method to determine when to stop extracting factors may depend on when the “random” variability has significantly decreased (i.e., very little random variability left). A correlation matrix may be used to determine the variance amongst each of the variables. The total variance in that matrix may be equal to the number of variables.

In contrast to the variable reduction methods of principal component analysis described above, principal factor analysis may also be performed by computer system 102 of FIG. 1 to determine the structure in the relationships between variables. The student data may be used to form a “model” for principal factor analysis. For example, the student data may be dependent on at least two components. First, there may be one or more underlying common factors. Each item may measure some part of this common aspect. Second, each item may also capture a unique aspect (of the common aspect) that may not be addressed by any other item.

If this model is correct, the factors may not extract substantially all variance from the items. Rather, only that proportion that is due to the common factors and shared by several items may be extracted. The proportion of variance of a particular item that is due to common factors (shared with other items) is called communality. The communalities for each variable may be estimated (i.e., the proportion of variance that each item has in common with other items). The proportion of variance that is unique to each item may then the respective item's total variance minus the communality. A common starting point is to use the squared multiple correlation of an item with all other items as an estimate of the communality. Alternatively, various iterative post-solution improvements may be made to the initial multiple regression communality estimate.

A characteristic that distinguishes between the two factor analytic models described above is that in principal components analysis (i.e., factor reduction) may assume that substantially all variability in an item should be used in the analysis, while principal factors analysis (i.e., structure detection) may use the variability in an item that it has in common with the other items. In most cases, these two methods usually yield very similar results. However, principal components analysis is often preferred as a method for data reduction, while principal factors analysis is often preferred when the goal of the analysis is to detect structure.

Computer system 102 of FIG. 1 configured with factor analysis applications programming (e.g., as part of applications 108) may identify which data elements had increased significance in a student achieving one or more goals. System 102 may use quantitative techniques, such as data gathering from registration system 120 (e.g., swipes of student identification card 122, proximity readings of card 122, registration of digital device 124 configured with student information, capturing student identification information entered from student computer 126, etc.) to collect data about a student concerning their attendance and participation in various events or utilization of resources. The captured data (taken alone or in combination with other student data that may be stored, e.g., with campus academic system 116) may be used as input for a statistical application (e.g., applications 108) of computer system 102 of FIG. 1, which may process the data using factor analysis. System 102 may yield a set of underlying attributes (i.e., factors). Upon determination of the factors, system 102 may construct perceptual maps, graphs, or other textual or visual output to indicate the correlation of particular factors and student achievement of one or more defined goals. System 102 may present such maps, graphs, and/or text in displays for presentation to, for example, a administrator, a faculty member, or any other suitable person using computer 104 or 118.

Computer system 102 may be configured with programming that is executed to perform factor analysis on one or more elements of data to isolate underlying factors that summarize the resultant information as it relates to attainment of one or more student goals. The factor analysis may be an interdependence technique, wherein one or more sets of interdependent relationships may be examined. The factor analysis may reduce the rating data on different attributes to a few important dimensions (e.g., whether the student goal was achieved, and which activities had increased influence in goal completion). This reduction is possible because the attributes are related (e.g., the student participated in the events, and the defined goal was met). The rating given to any one attribute is partially the result of the influence of other attributes. Thus, system 102 may determine which activities or events in which a student participated (or, e.g., other captured data) had the most influence in a student achieving one or more defined goals. The statistical programming (e.g., application 108) implemented on system 102 may deconstruct the rating (i.e., raw score) into one or more components, and reconstruct the partial scores into underlying factor scores. The amount of correlation between the initial raw score and the final factor score is referred to as factor loading.

As indicated in block 210 of FIG. 2, goals for learning outcomes for a student may be defined. Exemplary student goals may be illustrated in display 300 of FIG. 3, which may be provided by computer 102 of FIG. 1 to user computer 104 or user computer 118. For example, an administrator using computer 118 may establish goals for a particular student, identified by student information 302. Student information 302 may include student name, identification number, gender, class year (e.g., freshman, sophomore, etc.), anticipated graduation date, race, certificate or degree program, or any combination thereof, or any other suitable information.

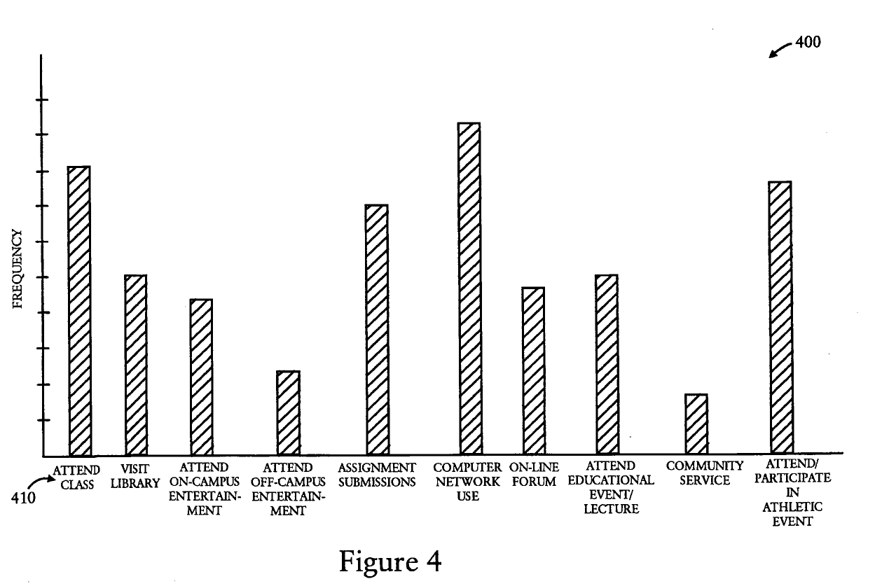

An administrator or other user operating user computer 104 or 118 may select “student data graph” button 304, which may present display 400 of FIG. 4. Display 400 may be a graphical representation of captured student data registration system 120 of FIG. 1. Although data for only one student is depicted in display 400, computer system 102 may be configured to generate similar displays for a plurality of students. For example, displays may present data for students of a particular major (e.g., physics, chemistry, English, communications, engineering, etc.), of a particular class year (e.g., freshman, sophomore, junior, senior, graduate student, etc.), of a particular race or gender, or any other suitable grouping, or any combination thereof.

As shown in display 400, the frequency of events may be collated by system 102 and presented based on one or more categories. Exemplary event frequencies that may be indicated graphically, numerically, or in any other suitable manner may include, but are not limited to: class attendance, library usage, attendance of on-campus entertainment, attendance of off-campus entertainment, class assignment submissions (e.g., using an on-line assignment submission system), computer network use (e.g., as determined by user login information), participation in on-line educational community (e.g., physics class forum, student club forum, etc.), educational event or lecture, utilization of off-campus merchant, community service, attendance or participation in athletic event, or any other suitable category, or any combination thereof. Selection of one or more of the categories may present a display that may indicate the specific breakdown of data into additional categories.

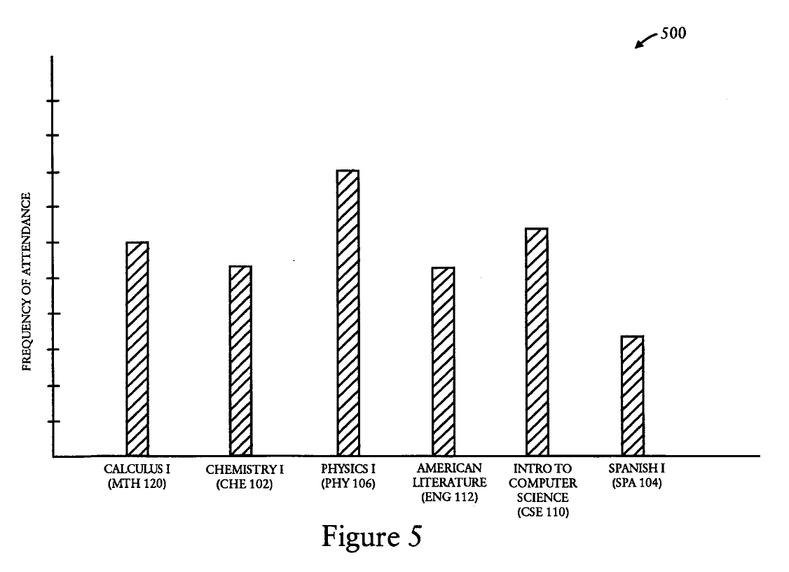

For example, class attendance frequency 410 may be selected from display 400 of FIG. 4. Accordingly, upon this selection, display 500 of FIG. 5 may be presented indicating the frequency of attendance for each class. As shown, the student may be enrolled in courses such as Calculus I, Chemistry I, Physics I, American Literature, Introduction to Computer Science I, and Spanish I. The student data captured by registration system 120 of FIG. 1 from student identification card 122, student digital device 124, and/or student computer 126 may be used by computer system 102 in generating display 500. Although not shown in FIG. 5, display 500 may be configured to include the number of attendances for each class based on the total number of classes for a period of time (e.g., semester, year, etc.).

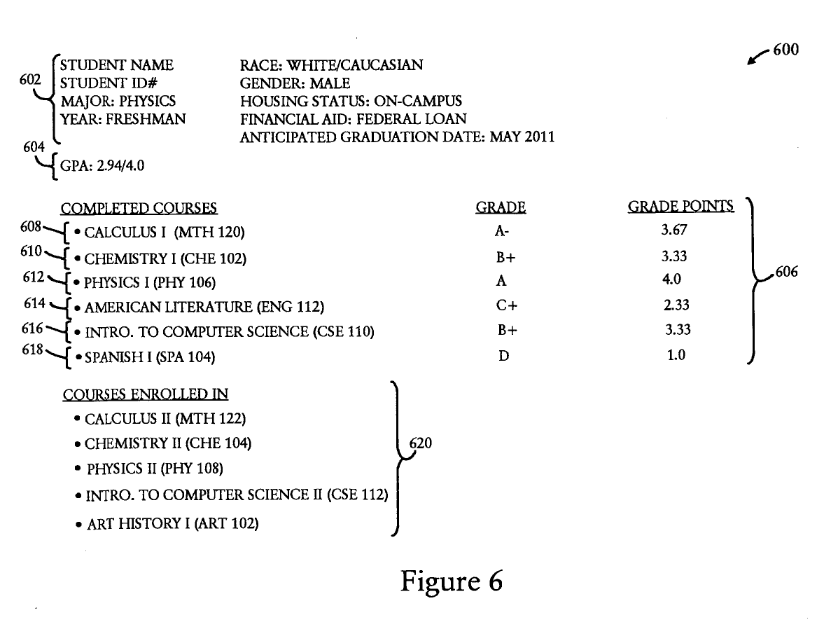

Turning again to display 300 of FIG. 3, an administrator or other individual may select “student education data button” 306 to present display 600 illustrated in FIG. 6. Student identification information 602 may include student name, student identification number, major field of study, class year (e.g., freshman sophomore, etc.), anticipated graduation date, race, gender, housing status (e.g., on-campus, off-campus, etc.), financial aid (e.g., scholarships, loans, grants, work-study, etc.), or any other suitable information, or any combination thereof. Display 600 may also include the student's grade point average (GPA) 604, as well as completed courses 606, and enrolled courses 620 that a student is presently participating in. Data for display 600 may be retrieved by computer system 102 of FIG. 1 from data storage 112, other campus computer systems 114, campus academic systems 116, computer 104 or 118, from event registration system 120, or any other suitable device, or any combination thereof.

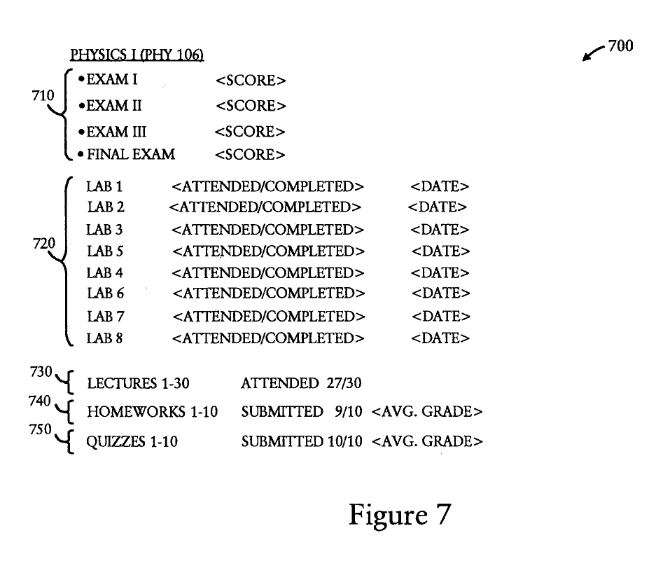

An administrator or other suitable user of computer 104 or 118 may, for example, select course 608, 610, 612, 614, 616, or 618 from completed courses 606 to obtain additional information related to these courses from computer system 102. For example, selection of course 612, may present display 700 of FIG. 7, that provides information related to the student's performance in Physics I class, such as number of exams and exam scores (e.g., exams 710), labs attended 720, class lectures attended 730 (e.g., attended 27 out of 30 total class lectures), number of homework assignments submitted (e.g., homework assignments submitted electronically that identified the student) and average grade of homework assignments (e.g., homework assignments 740), number of quizzes and average quiz grade (e.g., quizzes 750), or any other suitable information. Data for display 700 may be retrieved by computer system 102 of FIG. 1 from data storage 112, other campus computer systems 114, campus academic systems 116, computer 104 or 118, from event registration system 120, or any other suitable device, or any combination thereof.

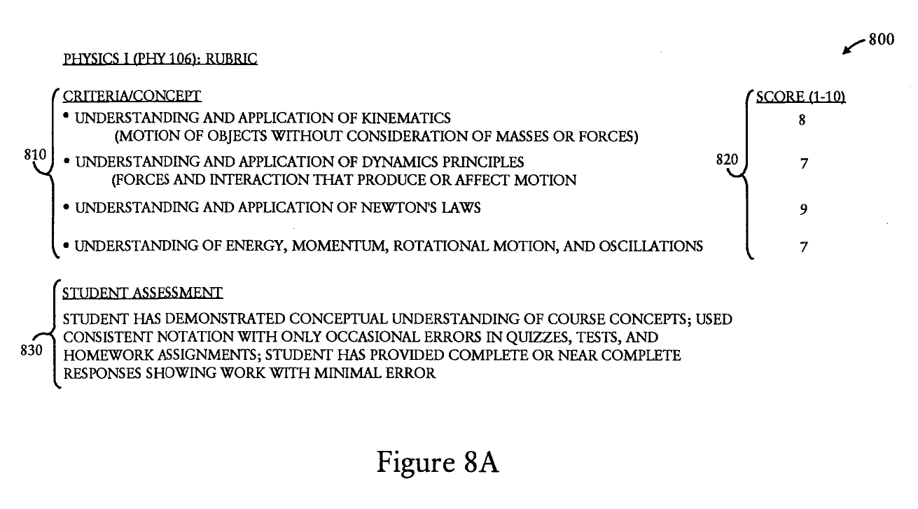

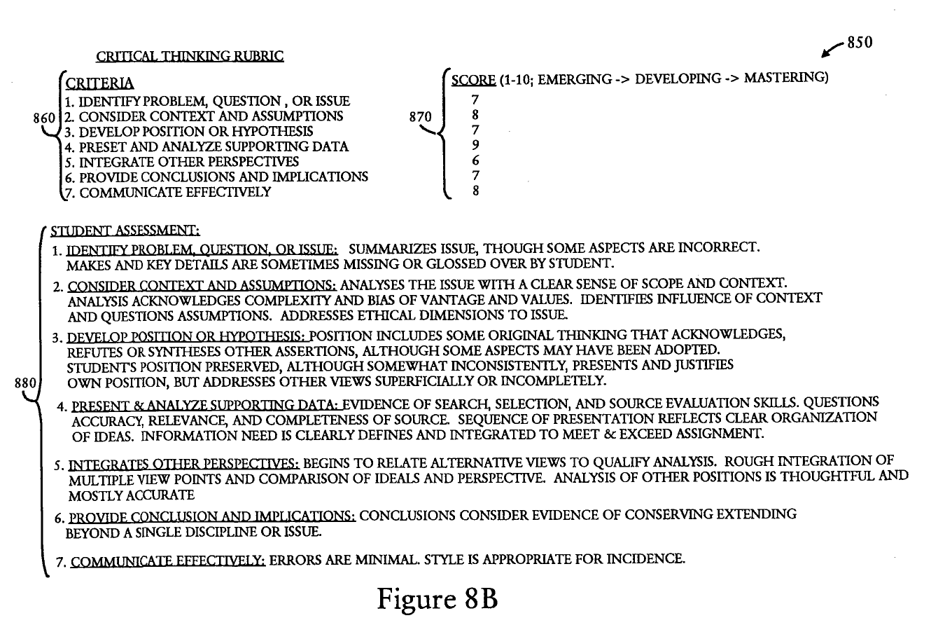

Turning again to display 300 of FIG. 3, an administrator or other user operating user computer 104 or 118 may select drop down rubric menu 307, where a user may select from one or more rubrics (e.g., rubrics for a particular course, critical thinking rubric, communication rubric, etc.). For example, an administrator or other user may select the course rubric option 308a from rubric menu 331, and may further select Physics I course rubric 308b. Computer system 102 may accordingly present display 800 of FIG. 8A indicating information related to rubrics for the Physics I course. Concepts 810 may present course concepts that a student may receive a score for, and upon completion of the Physics I course, may have demonstrated emerging, developing, or mastering knowledge of the identified course concepts. For example, as indicated in display 800, concepts 810 may relate to student understanding and applying concepts of kinematics, dynamics, Newton's laws, energy, motion momentum, rotational motion, and/or oscillations, or any other suitable Physics course concepts. Score 820 may indicate a score that a student has received (e.g., between 1-10 or any other suitable score, etc.) for each Physics course concept indicated in concepts 830. For example, a student may receive a score of 8 out of 10 for the student's demonstrated understanding and application of kinematics concepts. An administrator, faculty member, or other user may provide a score for a student for concepts 810 and/or 830. One or more data elements (e.g., concept scores) for display 800 may be retrieved by computer system 102 of FIG. 1 from data storage 112, other campus computer systems 114, campus academic systems 116, computer 104 or 118, from event registration system 120, or any other suitable device, or any combination thereof.

Student assessment 830 may provide further assessment of a student's demonstrated understanding and abilities to apply course concepts for the Physics I course. For example, student assessment 830 may indicate that a student has demonstrated conceptual understanding of course concepts, used consistent notation with only occasional errors (e.g., in quizzes, tests, and/or homework assignments), and provided complete or near complete responses showing work with minimal error (e.g., on quizzes, tests, and/or homework assignments, etc.). Data for student assessment may be obtained, for example, by computer system 102 of FIG. 1 from data storage 112, other campus computer systems 114, campus academic systems 116, computer 104 or 118, from event registration system 120, or any other suitable device, or any combination thereof.

The rubric data for each course may be from data storage 112, other campus computer systems 114, or campus academic system 116 (e.g., as entered by a faculty member or administrator using computer 118 coupled to system 116), or any combination thereof. The rubric data may be, for example, captured during the pre-graduation period of student attendance at an educational institution. Similar rubric data may be available for one or more criteria or concepts tested by exams 710, labs 720, lectures 730, homeworks 740, or quizzes 750, or any combination thereof. A user may select one or more items presented in exams 710, labs 720, lectures 730, homeworks 740, or quizzes 750, and computer system 102 may present one or more displays with related rubric information. Alternatively, a user may select rubrics related to a course from drop down menu 307 of FIG. 3.

Turning again to display 300 of FIG. 3, an administrator or other user operating user computer 104 or 118 may select drop down rubric menu 307, where a user may select critical thinking rubric 309. Computer system 102 may accordingly present critical thinking rubric display 850 of FIG. 8B. Display 480 may include criteria 482 for the critical thinking rubric, such as, for example: (1) identify the problem, question or issue; (2) consider the influence context and assumptions; (3) develop a position or hypothesis; (4) present and analyze supporting data; (5) integrate other perspectives; (6) provide conclusions and implications; and (7) communicate effectively. Criteria 482 may have one or more of the preceding exemplary elements, or may have any other suitable elements. Score 484 may indicate, for example, a score of 1-10 or any other suitable scoring range. The value of score 484 may indicate a student's emerging, developing, or mastering abilities for a particular criteria 482 of the critical thinking rubric. A faculty member, administrator, or other user may provide a student with a score for a particular criteria. The rubric data for each course may be from data storage 112, other campus computer systems 114, or campus academic system 116 (e.g., as entered by a faculty member or administrator using computer 118 coupled to system 116), or any combination thereof.

Student assessment 486 may provide written detail regarding a student's performance in one or more criteria area indicated in criteria 482. For example, for the criteria of identifying a problem, question, or issue, the student may be assessed as having demonstrated the ability to summarize the issue, although some aspects of the summary are incorrect and various nuances and key details may be missing or glossed over by the student.

Turning again to display 300 of FIG. 3, the administrator or other individual may add or remove goals for a student, or edit existing goals. These goals may be institutional level goals 310, program level goals 320, or course level goals 330, or any combination thereof. Institutional goals 310, program level goals 320, or course level goals 330 may be edited by selecting a particular goal. Institutional goals 310 may be added or removed by selecting “add/remove goal(s)” button 312. Similarly, an administrator or other individuals may add or remove program level goals 320 or course level goals 330 by selection of “add/remove goal(s)” button 322 or 332, respectively.

Institutional level goals 310 for a student may include, but are not limited to: student attaining graduation; student attaining graduation within a particular period of time (e.g., complete a degree within four years); successful completion of courses by a student with at least a satisfactory grade; average attainment of outcomes based on at least one rubric; having the student attend or participate in at least one educational lecture, cultural event, athletic activity, student club, or on-line community; stimulate students as lifelong learners in the arts and sciences; and/or enable students to think critically and to communicate their ideas effectively. An administrator or other user may select “assess student institutional level goals button” 314. This selection may transmit a request to computer system 102 (FIG. 1) to determine which student captured data or other data attains one or more institutional level goals for a student, and which one or more factors contributed to the achievement of the one or more goals.

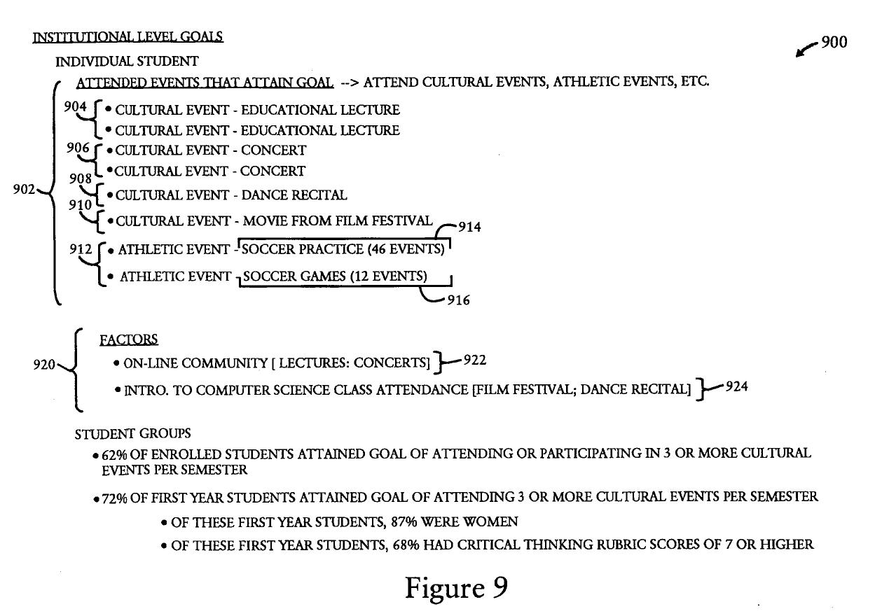

Upon selection of “assess student institutional level goals” button 314, computer system 102 may present display 900 of FIG. 9. Display 900 may indicate events 902 that a student has attended or participated in that may achieve one or more institutional level goals. The data captured using registration system 120 as described above (taken alone or in combination with other student data that may be stored, e.g., with campus academic system 116) may be used as input for a statistical application (e.g., applications 108) of computer system 102 of FIG. 1, and computer system 102 may determine whether one or more goals have been achieved. Data for display 900 may also be retrieved and/or processed by computer system 102 from data storage 112, other campus computer systems 114, campus academic systems 116, computer 104 or 118, from event registration system 120, or any other suitable device, or any combination thereof.

For example, as indicated in display 900, the student may have attended cultural events such as educational lectures 904, concerts 906, dance recital 908, and movie 910 from the campus film festival sponsored by the foreign student association that indicate achieving the institutional level goal of encouraging attendance and participation in educational lectures, cultural events, athletic activities, and community service (e.g., as indicated in institutional level goals 310 of FIG. 3). Display 900 may also indicate that the student was a member of the educational institution's soccer team, and may indicate the number of practices attended 914 and number of games played 916. In addition, factors 920 may be determined by factor analysis of the captured student data, other student-related data, or any combination thereof by, e.g., computer 102 of FIG. 1. Factors 920 indicate which data elements had increased relevance in a student in achieving institutional level goals (e.g., institutional level goals 310 of FIG. 3). As indicated in display 900 by factors 922, the exemplary student's participation in educational lectures 904 and concerts 906 may be from the student's participation in the educational institution's on-line community. Factors 924 indicate that dance recital 908 and film festival attendance (i.e., movie 910) may have an increased correlation with the student's attendance for Introduction to Computer Science I (e.g., a professor or teaching assistant may have encouraged students to attend these particular events). Although FIG. 9 illustrates goal attainment information for the institutional goal of encouraging attendance and participation in educational lectures, cultural events, athletic activities, and community service, display 900 of FIG. 9 may also present other institutional level goals (e.g., as indicated in institutional level goals 310 of FIG. 3) and the factors correlated thereto by computer system 102.

Display 930 of FIG. 9 may also indicate information related to one or more students (e.g., student groups, etc.) achieving institutional level goals. For example, computer system 102 utilizing applications 108 may present display 932, which indicates that 62% of enrolled students attained the goal of attending three or more cultural events per semester. Computer system 102 may also present display 934, which indicates that 79% of first year students attained the goal of attending three or more cultural events per semester. Computer system 102 may indicate in display 936 that 87% of these first year students who met this goal were women. Display 938, as presented by computer system 102, may indicate that of the first year students who met the goal of attending three or more cultural events per semester, 68% had critical thinking rubric scores of 7 or higher for each criteria of the rubric.

Turning again to FIG. 3, program level goals 320 may be, for example, based on a student's declared major (e.g., English, engineering, chemistry, communications, education, etc.). For example, a student who has declared physics as a major may have a program goal of achieving a particular grade (e.g., a “B” grade or better) or grade point average (e.g., at least 3.0 on a 4.0 grading scale) in core courses (e.g., Physics I, Physics II, Calculus I, Calculus II, etc.) for qualification into the degree program of physics. Other exemplary program goals for a physics major program may include, but are not limited to: enabling a student to apply scientific problem solving techniques to classical areas of physics as well as modern physics; preparing physics student for graduate work in physics or engineering; and/or preparing students for careers using physics.

Also, the educational institution may, for example, establish one or more general educational requirements which may be program goals for a student. For example, the defined general education requirement goals for a student may have the student successfully complete coursework in a foreign language (e.g., Spanish, French, Japanese, etc.), at least one course with a substantial writing component (e.g., creative writing, American Literature, journalism, etc.), an arts-related performance or criticism class (e.g., piano performance, dance, art history, etc.), a class or series of classes requiring physical activity (e.g., tennis, hockey, basketball, running, swimming, etc.), or any other suitable general education requirement (e.g., time management seminar, freshman seminar class, health and wellness class, nutrition class, etc.).

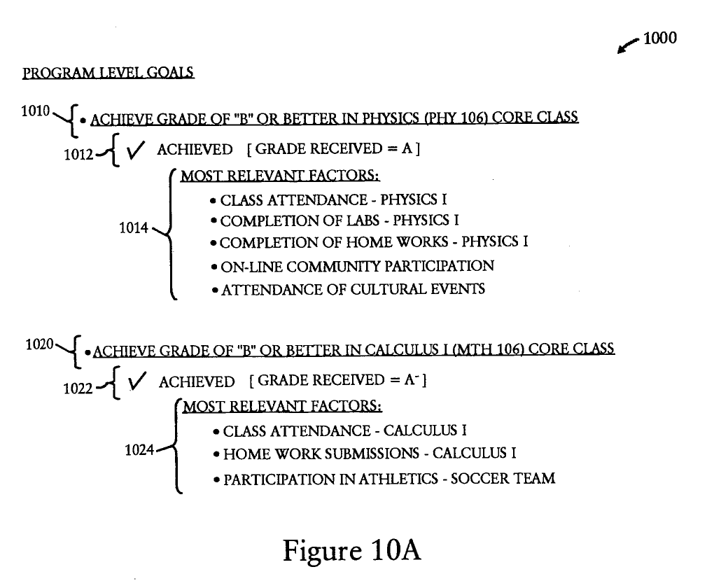

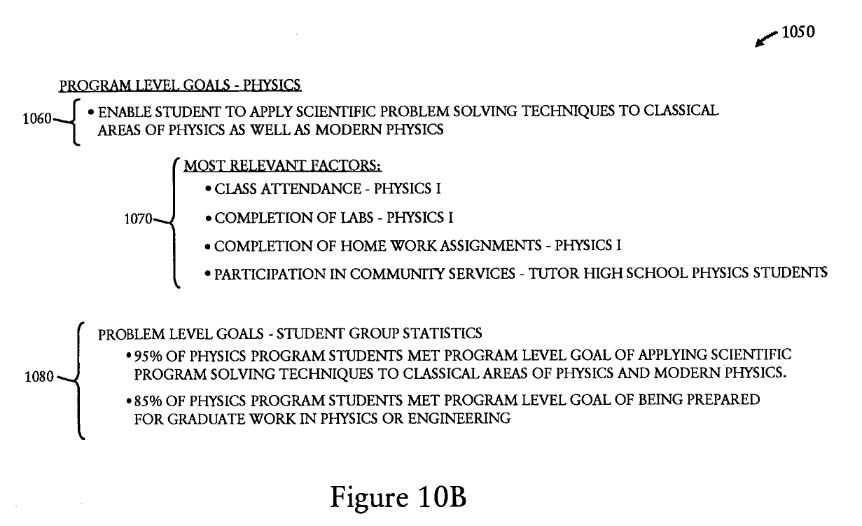

Upon selection of “assess student program level goals” button 324 in display 300 of FIG. 3, computer system 102 (FIG. 1) may present display 1000 of FIG. 10A. Display 1000 is an exemplary display screen illustrating one or more factors (i.e., factors 1014, factors 1024) may have increased correlation with a student achieving (or not achieving) one or more goals for learning outcomes. For example, a program level goal of achieving at least a predefined grade (e.g., a grade of “B” or better) in a Physics I class (i.e., goal 1010) and Calculus I class (i.e., goal 1020) in order to be considered for a physics degree program at a university or other educational institution.

As shown in display 1000, the program level goal of achieving a grade of “B” or better in Physics I is indicated as goal 1010, and goal achievement 1012 indicates that goal 1010 has been attained, as a grade of A was received by the student in Physics I. Computer system 102 may determine using the factor analysis programming (e.g. applications 108) as described above that the frequency of class attendance, attendance for physics labs 1-8, performance in quizzes 1-10 and submitting homework problem sets were highly correlated with the student achieving goal 1010. These relevant factors are indicated as factors 1014 in display 1000.

Factors 1014 also indicate that on-line community participation and attendance of cultural events were also relevant factors in the student achieving goal 1010. For example, the student may have participated in on-line discussions and other on-line social interaction with students. Some of the on-line interaction may have been social, but other portions may have been academically related. For example, the student may have had discussions with other Physics I students, teaching assistants, or a professor regarding physics topics covered in lecture, or topics pertaining to homework assignments or laboratory experiments. System 102 may also determine, for example, a high correlation between the student's attendance of on-campus attendance of cultural events (e.g., musical performances, art exhibits, dance performances, etc.) and the student achieving program level goal 1010. In the example, these events may also have high correlation in achieving institutional level goals such as successful completion of classes to graduate on-time and promotion of extracurricular activities that promote institutional and lifetime participation in cultural events.

Display 1000 also indicates goal 1020, which is to achieve a grade of “B” or better in Calculus I. Goal achievement 1022 indicates that goal 1020 was achieved, as the student received a grade of “A-” in Calculus I. Factors 1024 indicate that class attendance, homework submission and participation in athletics (e.g., soccer team) were determined by computer system 102 using factor analysis as having increased correlation with the student achieving goal 1020.

Upon selection of “assess student program level goals” button 324 in display 300 of FIG. 3, computer system 102 (FIG. 1) may also present display 1050 of FIG. 10B. Display 1050 may contain additional program goals and assessment of one or more students in achieving the program goals. For example, program goal 1060 for a Physics program may be to enable students to apply scientific problem solving techniques to classical areas of physics as well as modern physics. Computer system 102 may determine using factor analysis programming as described above that the student's class attendance for Physics I, the completion of labs and homework assignments for Physics I, and the student's participation in a community service program for tutoring high school students in Physics were highly correlated with the student achieving goal 1060.

Computer system 102 may determine factors 1070, which may have increased correlation with a student achieving a program level goal (e.g., enabling a student to apply scientific problem solving techniques to classical areas of physics as well as modern physics, etc.). Factors 1070 that may have increased correlation with the exemplary goal may include, but are not limited to: a student's class attendance for Physics I; completion of laboratories for Physics I; completion of homework assignments for Physics I; and participation in a community service tutoring program for tutoring high school physics students.

Computer system 102 utilizing applications 108 may determine and present information related to the achievement of program level goals for a plurality of students and present the information in display 1080. Data for display 1080 may be retrieved by computer system 102 for use with applications 108 from, foe example, data storage 112, other campus computer systems 114, campus academic systems 116, computer 104 or 118, from event registration system 120, or any other suitable device, or any combination thereof.

For example, display 1080 may indicate that 95% of physics program students for the educational institution met the program level goal of applying scientific problems solving techniques to classical areas of physics and modern physics. Display 1080 may also indicate, for example, that 85% of physics program students met the program level goal of being prepared for graduate work in physics or engineering. Although display 1080 may correlate student achievement of goals with one or more program level factors, other suitable correlations may be made by computer system 102 and presented in display 1080. Turning again to display 300 of FIG. 3, course level goals 330 for learning outcomes may also be defined for a student. Course level goals 330 may be, for example: an overall class grade (e.g., a passing grade or better); passing a particular number of examinations; submitting homework assignments; completion of one or more projects, laboratory experiments, or presentations; attendance at a predefined number of class lectures (e.g., at least 25 out of 30 lectures); attain the ability to explain motion of objects with consideration of their mass and forces that produce or affection their motion for a Physics I course; and/or introduce students to algorithm design and implementation in a modern, high-level programming language for an Introduction to Computer Science course or any other suitable course level goals.

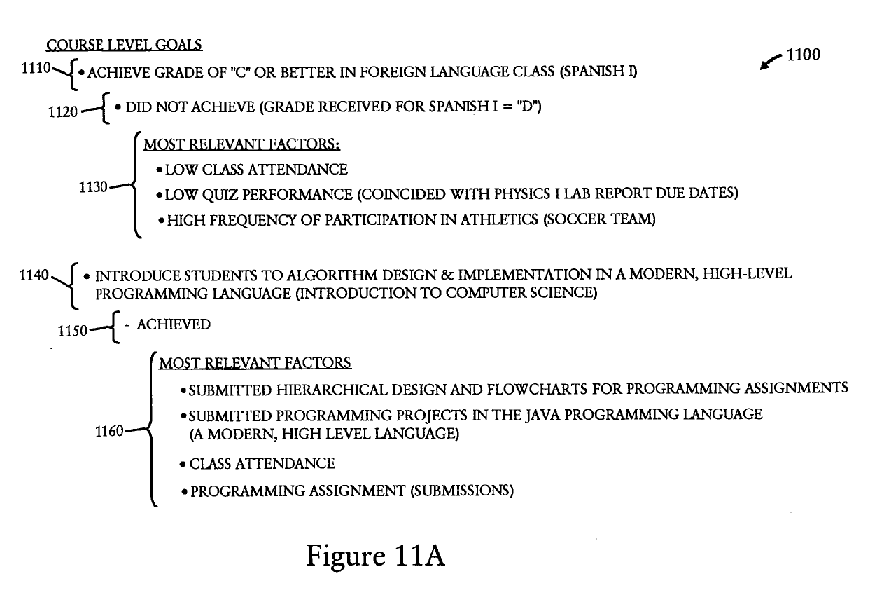

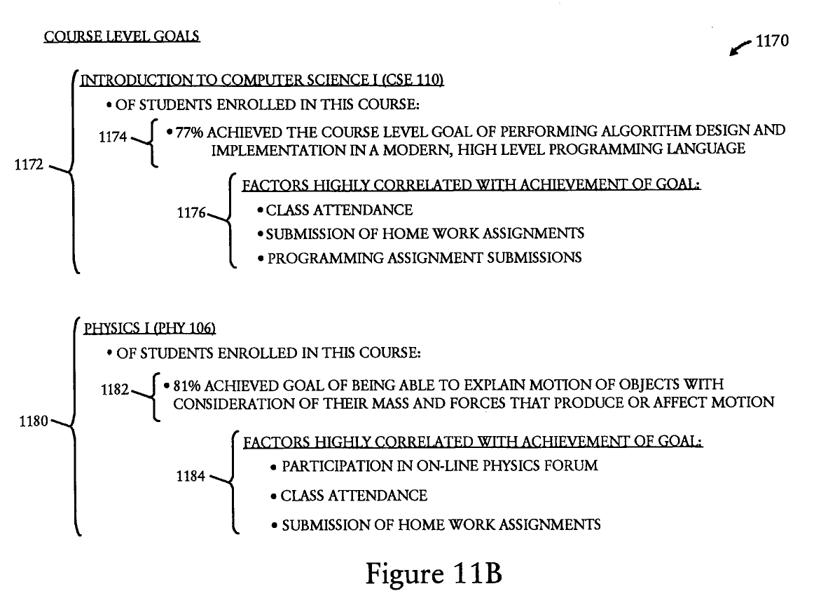

Selection of “assess student course level goals” button 334 may present display 1100 illustrated in FIG. 11. As indicated in display 1100, course level goal (i.e., goal 1110) was for the student to achieve a grade of “C” or better in a foreign language class (e.g. Spanish I). As indicated by goal achievement 1120, goal 1110 was not achieved, as the student received a grade of “D”. Factors 1130 indicate that low class attendance, low quiz performance, and participation in athletics (e.g., soccer team) had increased correlation with the student not achieving goal 1110. Computer system 102 (FIG. 1) enabled with factor analysis programming may determine a correlation between the constituent student efforts in the Physics I class and the student's poor performance in Spanish I. For example, system 102 may determine a high correlation between completion of Physics laboratory reports and the date of Spanish I quizzes. Thus, the correlation may indicate that the student's failure to achieve course level goal 1110 may be highly correlated with the student's efforts on Physics I lab reports that a student had to submit on a date that corresponded with the due date of the lab reports. System 102 may also find a high correlation, for example, between the student's participation in athletic activities and the student's failure to meet the course goals for the Spanish I class.

As indicated in display 1100, exemplary course level goal 1140 was to introduce students to algorithm design and implementation in a modern, high-level programming language for an Introduction to Computer Science course. As indicated by goal achievement 1150 and determined, for example, by applications 108 of computer system 108, goal 1140 was achieved. Factors 1160 determined by computer system 102 enabled with factor analysis programming as described above indicate the following factors had increased relevance in achieving goal 1140: the submission of hierarchical design diagrams and flowchart for programming assignments; submitting programming projects in the Java programming language (i.e., a modern, high-level programming language); and/or class attendance for Introduction to Computer Science I.

Computer system 102 may generate display 1170, which presents additional exemplary course level goal information. Display 1174 may indicate that of the students enrolled in Introduction to Computer Science I (CSE 110), 77% of the students achieved the course level goal of performing algorithm design and implementation in a modern, high-level programming language. Computer system 102 may determine and provide factors 1176, which may indicate factors with an increased correlation with achieving this goal, such as: class attendance, submission of homework assignments, and programming assignment submissions. Computer system 102 may also generate display 1180, which may indicate one or more factors with increased correlation with, for example, the defined Physics I (PHY 106) course level goal of students being able to explain motion of objects with consideration of their mass and forces that produce or affect motion. Display 1182 may indicate that 81% of students enrolled in Physics I achieved this goal. Factors 1184 may be determined by computer system 102 using applications 108, and may indicate factors that have increased correlation with the course level goal. For example, factors 108 may include a student's participation in an on-line physics forum, Physics I class attendance, and submission of homework assignments for Physics I.

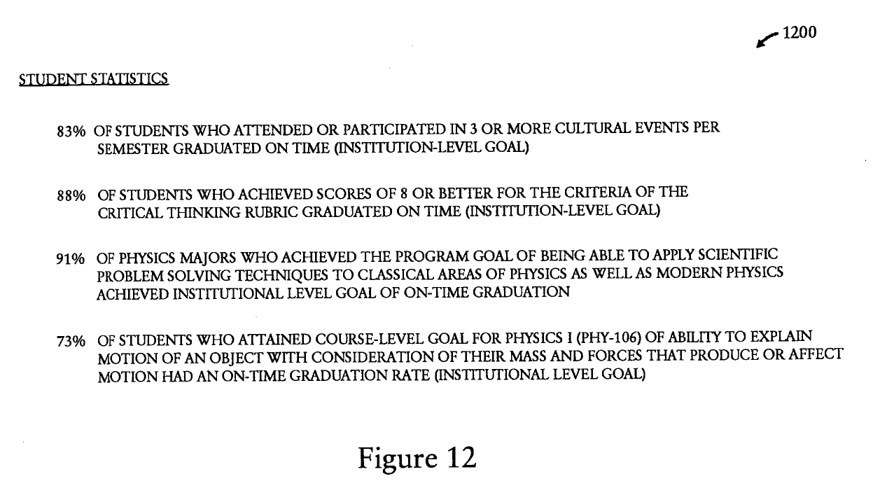

Turning again to display 300 of FIG. 3, the administrator or other user may select goal statistics button 336, and computer system 102 may present display 1200 of FIG. 12. Although the below-described examples for display 1200 relate to correlation with on-time graduation, other suitable correlations may be made with any other institutional level, program level, or course level goals, or any combination thereof.

As determined by computer system 102 using applications 108, display 1210 may indicate that 83% of students who attended or participated in three or more cultural events per semester achieved on-time graduation. Display 1220 may indicate that 88% of students who achieved scores of 8 or better for the criteria of the critical thinking rubric achieved on-time graduation from the educational institution. Computer system 102 may also present display 1230, which may indicate that 91% of physics majors who achieved the Physics program goal of being able to apply scientific problem solving techniques to classical areas of physics as well as modern physics also achieved on-time graduation. As determined by computer system 102 and presented in display 1240, 73% of students who attained the course-related goal for Physics I (PHY 106) for the ability to explain motion of an object with consideration of their mass and forces that produce or affect motion had an on-time graduation rate.

The detailed description set forth above in connection with the appended drawings is intended as a description of various embodiments and is not intended to represent the only embodiments which may be practiced. The detailed description includes specific details for the purpose of providing a thorough understanding of the embodiments. However, it will be apparent to those skilled in the art that the embodiments may be practiced without these specific details. In some instances, well known structures and components are shown in block diagram form in order to avoid obscuring the concepts of the exemplary embodiments.

It is understood that the specific order or hierarchy of steps in the processes disclosed is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The previous description is provided to enable any person skilled in the art to practice the various embodiments described herein. Various modifications to these embodiments will be readily apparent to those skilled in the art, and the generic principles defined herein may be applied to other embodiments. Thus, the claims are not intended to be limited to the embodiments shown herein, but is to be accorded the full scope consistent with the language claims, wherein reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method for electronically assessing student performance in achieving one or more learning outcomes, comprising:
defining one or more goals for the one or more learning outcomes for a student;
capturing student interaction data, wherein the student interaction data has one or more data elements;
determining whether the student has achieved the one or more goals based on the captured student interaction data; and
determining which captured data elements have increased correlation with the student attaining the defined one or more goals.

2. The method of claim 1, wherein the one or more learning outcomes relate to student level outcomes, program level outcomes, or course level outcomes, or any combination thereof.

3. The method of claim 1, wherein the capturing the student interaction data comprises swiping a card configured with student data at an event, reading a card configured with student data with a proximity reader at an event, retrieving student data stored on an electronic device via a wired or wireless communication interchange, recording a computer login event using student identifier data, or digitally capturing student identification information from an electronically submitted communication, or any combination thereof.

4. The method of claim 3, wherein the capturing of the student data comprises capturing student presence data, non-presence data, or any combination thereof.

5. The method of claim 4, wherein the capturing of the student presence data indicates student class attendance, student activity attendance, student educational event attendance, student cultural event attendance, student athletic event attendance, student participation in one or more on-line communities, student entertainment attendance, or any combination thereof.

6. The method of claim 4, wherein the capturing of non-presence data indicates student patronage of on-campus merchants, student patronage of off-campus merchants, student patronage of on-line merchants, student utilization of an on-campus resource, student utilization of an off-campus resource, student electronic submission of an assignment, or student electronic submission of student identification information, or any combination thereof.

7. The method of claim 1, wherein the determining whether the student has achieved one or more goals further comprises utilizing student demographic data, student organization affiliation data, student courses completed data, student degree or certificate program data, student grade data, student activity data, or student community service participation data, or any combination thereof.

8. The method of claim 1, wherein the determining which captured data elements have increased correlation with attaining the defined one or more goals further comprises applying factor analysis.

9. A system for electronically assessing student performance in achieving learning outcomes, comprising:
a programmable computer configured to:
receive one or more goals for the one or more learning outcomes for a student;
capture student interaction data, wherein the student interaction data has one or more data elements;
determine whether the student has achieved the one or more goals based on the captured student interaction data; and
determine which captured data elements have increased correlation with the student attaining the received one or more goals.

10. The system of claim 9, wherein the one or more learning outcomes relate to student level outcomes, program level outcomes, or course level outcomes, or any combination thereof.

11. The system of claim 9, wherein the programmable computer configured to capture the student interaction data is further configured to receive card swipe data from a card configured with student data at an event, read a card configured with student data with a proximity reader at an event, receive student data stored on an electronic device via a wired or wireless communication interchange, record a computer login event using student identifier data, or any combination thereof.

12. The system of claim 11, wherein the programmable computer configured to capture the student interaction data is further configured to receive student presence data, non-presence data, or any combination thereof.

13. The system of claim 12, wherein the programmable computer configured to capture the student interaction data is further configured to capture student presence data that indicates student class attendance, student activity attendance, student educational event attendance, student cultural event attendance, student athletic event attendance, student participation in one or more on-line communities, student entertainment attendance, or any combination thereof.

14. The system of claim 12, wherein the programmable computer configured to capture the non-presence data indicates student patronage of on-campus merchants, student patronage of off-campus merchants, student patronage of on-line merchants, student electronic submission of an assignment, student utilization of an on-campus resource, student utilization of an off-campus resource, or student electronic submission of student identification information, or any combination thereof.

15. The system of claim 9, wherein the programmable computer configured to determine whether the student has achieved one or more goals is further configured to utilize student demographic data, student organization affiliation data, student courses completed data, student degree or certificate program data, student grade data, student activity data, or student community service participation data, or any combination thereof.

16. The system of claim 9, wherein the programmable computer configured to determine which captured data elements have increased correlation with attaining the defined one or more goals is further configured to apply factor analysis.

17. Computer readable media containing programming instructions for assessing student performance in achieving one or more learning outcomes, that upon execution thereof, causes one or more processors to perform the steps of:
receiving one or more goals for the one or more learning outcomes for a student;
capturing student interaction data, wherein the student interaction data has one or more data elements;
determining whether the student has achieved the one or more goals based on the captured student interaction data; and
determining which captured data elements have increased correlation with the student attaining the received one or more goals.

18. The method of claim 17, wherein the one or more learning outcomes relate to student level outcomes, program level outcomes, or course level outcomes, or any combination thereof.

19. The computer readable media of claim 17, wherein the capturing the student interaction data comprises swiping a card configured with student data at an event, reading a card configured with student data with a proximity reader at an event, retrieving student data stored on an electronic device via a wired or wireless communication interchange, recording a computer login event using student identifier data, or digitally capturing student identification information from an electronically submitted communication, or any combination thereof.

20. The computer readable media of claim 19, wherein the capturing of the student data comprises capturing student presence data, non-presence data, or any combination thereof.

21. The computer readable media of claim 20, wherein the capturing of the student presence data indicates student class attendance, student activity attendance, student educational event attendance, student cultural event attendance, student athletic event attendance, student participation in one or more on-line communities, student entertainment attendance, or any combination thereof.

22. The computer readable media of claim 20, wherein the capturing of non-presence data indicates student patronage of on-campus merchants, student patronage of off-campus merchants, student patronage of on-line merchants, student electronic submission of an assignment, student utilization of an on-campus resource, student utilization of an off-campus resource, or student electronic submission of student identification information, or any combination thereof.

23. The computer readable media of claim 17, wherein the determining whether the student has achieved one or more goals further comprises utilizing student demographic data, student organization affiliation data, student courses completed data, student degree or certificate program data, student grade data, student activity data, or student community service participation data, or any combination thereof.

24. The computer readable media of claim 17, wherein the determining which captured data elements have increased correlation with attaining the defined one or more goals further comprises applying factor analysis.

25. A method for electronically correlating student interactions with student performance in achieving one or more learning outcomes, comprising:
capturing student interaction data, wherein the student interaction data has one or more data elements;
correlating at least some of the captured data elements with the one or more learning outcomes; and
determining which captured data elements have increased correlation with the student achieving the one or more learning outcomes.
